(19) United States
(12) Patent Application Publication
(10) Pub. No.: US 2023/0418535 A1
(43) Pub. Date: Dec. 28, 2023

(54) IMAGE READING APPARATUS AND IMAGE READING METHOD

(71) Applicant: SHARP KABUSHIKI KAISHA, Sakai City (JP)

(72) Inventor: Hidemitsu IMAI, Sakai City (JP)

(21) Appl. No.: 18/209,511

(22) Filed: Jun. 14, 2023

(30) Foreign Application Priority Data
Jun. 24, 2022 (JP) 2022-101991

(51) Int. Cl. G06F 3/12

(52) U.S. Cl. CPC G06F 3/1292; G06F 3/1242; G06F 3/1256; G06F 3/1204; G06F 3/121

(57) ABSTRACT

An image reading apparatus includes: a document reader that reads an image of a set document; a communicator that receives an instruction related to execution of a remote scan job from an external device; a job controller that controls the document reader to read the document on the basis of the instruction and to send a read image to the external device; and an operation acceptor that displays an operation screen and accepts an operation from a user via the displayed operation screen. When accepting the operation via the operation screen, the job controller determines that such an operation is an operation related to a job different from the remote scan job, and sets a state where acceptance of the instruction related to the execution of the remote scan job is prohibited onward.

### BACKGROUND OF THE INVENTION

### Field of the Invention

The present disclosure relates to an image reading apparatus and an image reading method capable of executing a remote scan job and a different type of a job therefrom.

### Description of the Background Art

A remote scan is a scan job in which a user uses an external device (also referred to as a host) to make a setting and an execution instruction related to reading. The user sets a document on a document table or in a document feeder of an image reading apparatus, and then makes a setting and an execution instruction related to reading on the host, such as a personal computer (PC) communicatively connected to the image reading apparatus. The image reading apparatus that receives the instruction reads the document set on the document table or in the document feeder, and sends a read image to the host. A series of processing related to reading of the document is a remote scan job.

Compared to a type of the scan job (a push scan job) for which the user makes the setting related to reading, sets a destination of the read image, and gives the execution instruction on the image reading apparatus, the remote scan job is also referred to as a pull scan job. The remote scan has such an advantage that the user can make the setting related to reading while checking, on the host, quality and colors of the image read by the image reading apparatus.

Meanwhile, in the case where the image reading apparatus such as a multifunction peripheral connected to the host via a network is shared with other users, in particular, in the case where the host is located far from the image reading apparatus, the user cannot be present near the image reading apparatus at the time of reading in the remote scan. There is a possibility that, in a period from setting of the document to a start of reading, another user walks to the image reading apparatus to remove the set document or operates the image reading apparatus to make a setting or perform operation unintended by the user who intends to execute the remote scan.

In order to prevent such a situation, the following method has been disclosed. In the method, the user who intends to execute the remote scan job makes a document reading apparatus display a specific screen (for example, an online screen) and thereby notifies the other user that the document is set for the remote scan job. Furthermore, the following method is also disclosed in the related art that permits the remote scan even without display of the specific screen. The document reading apparatus includes: a setting device that makes settings (a first setting and a second setting) related to a pull scan function in response to the user instruction; and a determination device that determines whether to implement the pull scan function on the basis of a type (one of a first type to a third type) of a screen displayed on a display device. When receiving an execution instruction of the pull scan from an external device, the document reading apparatus compares the setting made by the setting device with the type of the screen displayed on the display device.

The first type of the screen is a pull scan screen to notify that the pull scan function is in use. The second type of the screen is a copy screen to instruct implementation of a copy function or a send screen to instruct implementation of a send function. The third type of the screen is a copy setting screen to set the copy function or a send setting screen to set the send function. In the first setting, the pull scan is executed when the first type or the second type of the screen is displayed, but the pull scan is not executed when the third type of the screen is displayed. In the second setting, the pull scan is executed when the first type of the screen is displayed, but the pull scan is not executed when the second type or the third type of the screen is displayed.

The following method is further proposed in the related art. In the method, the pull scan is executed in the document scanning apparatus that has the copy function and the send function and can execute the pull scan when the pull scan screen is displayed on the display device. In the case where a function selection screen, which is a first screen differing from the pull scan screen and on which the user selects a function to be used from plural functions including the copy function and the send function, is displayed on the display device, the pull scan is executed according to the instruction from the external device. However, when a second screen is displayed, the pull scan is not executed.

According to the related art, when the pull scan execution instruction is received from the external device, the determination on whether to permit the pull scan is made in relation to the screen that is displayed at the time. Thus, the specific screen has to be displayed to execute the pull scan. As examples of the screen on which the pull scan is not permitted, the copy setting screen and the send setting screen are described. As examples of the screen on which the pull scan is permitted, the pull scan screen and the function selection screen are described.

In recent years, the multifunction peripherals, each of which has more functions than the dedicated image reading apparatus, have been widespread. The multifunction peripheral can be considered as the image reading apparatus capable of executing a printer job, a copy job, and the like in addition to the scan job. Some of the dedicated image reading apparatuses can execute not only the pull scan job but also the push scan job. Since each of such image reading apparatuses provides a large number of operation screens for setting of the respective apparatus and the job, such an image reading apparatus allows the user to set an operation screen displayed in an initial state (hereinafter referred to as a default screen or an initial operation screen). The initial state is a state that is initiated, for example, with power-on of the apparatus, return of the apparatus from a power saving mode in which the apparatus stands by in a power saving state, a predetermined operation to reset the job setting, time-out at which a predetermined period elapses with no operation being performed, or the like being a trigger.

In the case where the user can set the default screen, for example, in the case where the user sets a copy job setting screen as the default screen, the displayed default screen has to be switched to the operation screen that permits the remote scan when the remote scan is executed. Examples of the operation screen that permits the remote scan are a remote scan screen and the function selection screen. The default screen is the operation screen that is displayed in the initial state. A state that is the initial state and where the operation screen is not operated is a state where there is a high possibility that no one is using the image reading apparatus and where the remote scan should be permitted. Nevertheless, it is a hassle that, in the above state, the default screen has to be switched to the specific screen that permits the remote scan.

The present disclosure has been made in view of a circumstance as described above and therefore permits a remote scan under a predetermined condition without a hassle of switching a default screen to a specific screen even when the default screen is set as a setting screen for a job different from a remote scan job.

### SUMMARY OF THE INVENTION

The present disclosure provides an image reading apparatus that includes: a document reader that reads an image of a set document; a communicator that receives an instruction related to execution of a remote scan job from an external device; a job controller that controls the document reader to read the document on the basis of the instruction and to send a read image to the external device; and an operation acceptor that displays an operation screen and accepts an operation from a user via the displayed operation screen. When accepting the operation via the operation screen, the job controller determines that such an operation is an operation related to a job different from the remote scan job, and sets a state where acceptance of the instruction related to the execution of the remote scan j ob is prohibited onward.

From a different perspective, the present disclosure also provides an image reading method for causing a controller that controls an image reading apparatus to: receive an instruction related to execution of a remote scan job from an external device; use a document reader to read a set document and send a read image to the external device; display an operation screen and accept an operation from a user via the displayed operation screen; and, when accepting the operation via the operation screen, determine that such an operation is an operation related to a job different from the remote scan job, and set a state where acceptance of the instruction related to the execution of the remote scan job is prohibited onward.

In the image reading apparatus according to the present disclosure, when accepting the operation via the operation screen, the job controller determines that such an operation is the operation related to the job different from the remote scan job, and sets the state where the acceptance of the instruction related to the execution of the remote scan job is prohibited onward. Thus, even in the case where a setting screen for the job different from the remote scan job is set as a default screen, the remote scan can be executed without a hassle of switching the default screen to a specific screen until the operation via the operation screen is accepted.

In other words, whether to execute the remote scan is determined not on the basis of whether the specific screen is displayed but on the basis of the user operation until a remote scan execution request is sent from the user who uses the external device. Therefore, even when the default display screen is a copy job screen, the remote scan can be executed without shifting the copy job screen to the specific screen.

The same operational effect can also be exerted by the image reading method according to the present disclosure.

### BRIEF DESCRIPTION OF THE DRAWINGS

FIG. 1 is a block diagram illustrating a configuration of a multifunction peripheral as an example of an image scanning apparatus in this embodiment.

FIG. 2 is an external perspective view of a portion corresponding to a document reader in the multifunction peripheral illustrated in FIG. 1.

FIG. 3 is an external perspective view illustrating a portion including a document table in the multifunction peripheral illustrated in FIG. 1.

FIG. 4 is an explanatory chart illustrating an example of an operation and communication flow at the time when the multifunction peripheral in this embodiment executes a remote scan job.

FIG. 5A is an explanatory view illustrating a situation where a document is set in a document transport unit of the multifunction peripheral illustrated in FIG. 1.

FIG. 5B is an explanatory view illustrating a state where the document is set on the document table of the multifunction peripheral illustrated in FIG. 1.

FIG. 6 is an explanatory view illustrating an example of a scanner driver screen related to the remote scan job in this embodiment.

FIG. 7 is an explanatory view illustrating an example in which a job acceptance prohibition state is notified on the scanner driver screen related to the remote scan job.

FIG. 8 is an explanatory view illustrating an example of a preview display screen of the scanner driver screen related to the remote scan job in this embodiment.

FIG. 9 is an explanatory chart illustrating an example of an operation and communication flow at the time when the multifunction peripheral in this embodiment executes a push scan.

FIG. 10 is an explanatory view illustrating an example of a home screen that is displayed in an operation acceptor in this embodiment.

FIG. 11 is an explanatory view illustrating an example of a scan job screen that is displayed in the operation acceptor in this embodiment.

FIG. 12 is an explanatory chart illustrating an example of processing to prevent confusion between the remote scan job and another job in this embodiment (a first embodiment).

FIG. 13 is an explanatory chart illustrating an example of the processing to prevent the confusion between the remote scan job and the other job in this embodiment (a second embodiment).

FIG. 14 is a flowchart illustrating an example of processing to determine whether to accept the remote scan job in the embodiment.

FIG. 15 is a first-half of a flowchart illustrating an example of processing to manage a remote scan acceptance prohibition flag in the embodiment.

FIG. 16 is a latter-half of the flowchart illustrating the example of the processing to manage the remote scan acceptance prohibition flag in the embodiment.

FIG. 17 is an explanatory view illustrating an example of a remote scan screen indicating that the remote scan job is currently set or executed in this embodiment.

### DESCRIPTION OF THE PREFERRED EMBODIMENTS

Hereinafter, a further detailed description will be made on the present disclosure with reference to the drawings. The following description is illustrative in all respects and should not be construed as limiting the present disclosure.

### First Embodiment

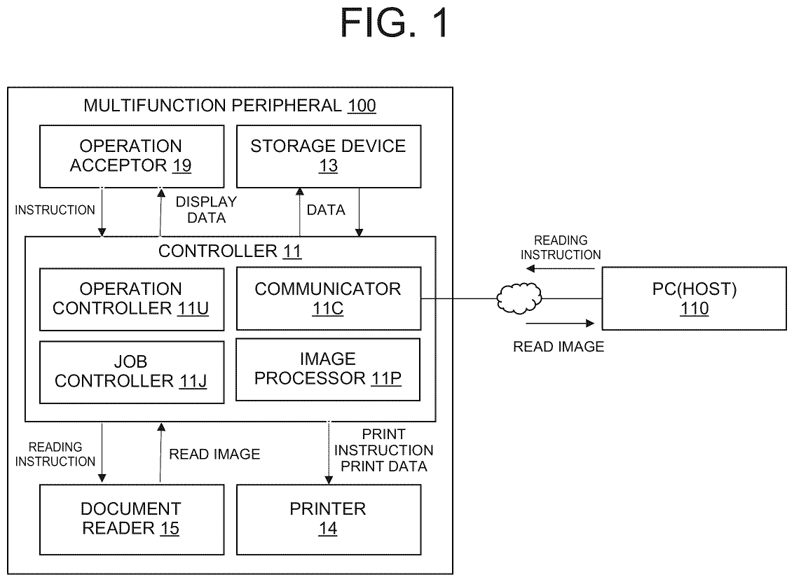

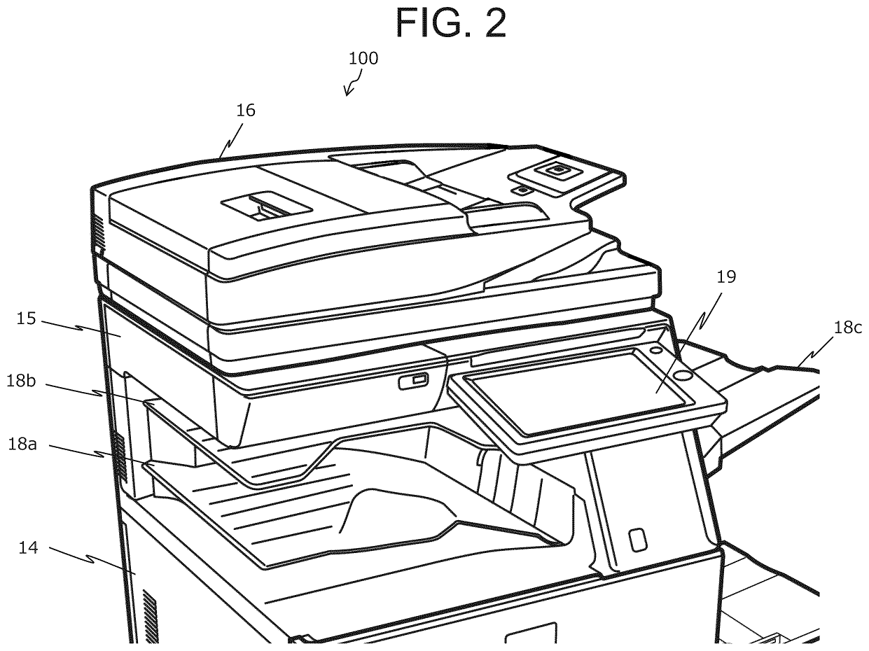

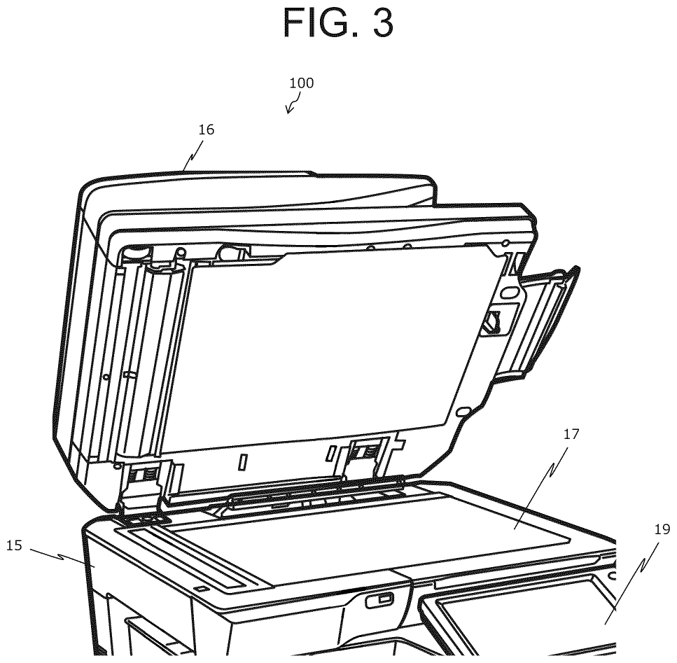

First, a description will be made on an image reading apparatus in this embodiment. FIG. 1 is a block diagram illustrating a configuration of a multifunction peripheral as an example of the image reading apparatus in this embodiment. FIG. 2 is an external perspective view of a portion corresponding to a document reader in the multifunction peripheral illustrated in FIG. 1. FIG. 3 is an external perspective view illustrating a portion including a document table in the multifunction peripheral illustrated in FIG. 1.

As illustrated in FIG. 1, a multifunction peripheral 100 includes a controller 11, a storage device 13, a printer 14, a document reader 15, and an operation acceptor 19. The controller 11 includes a communicator 11C, a job controller 11J, an image processor 11P, and an operation controller 11U.

The controller 11 mainly includes a processor and memory as hardware resources. In addition to the processor, the controller 11 includes a circuit that includes hardware resources such as an input/output interface circuit, a timer circuit, and a communication circuit.

Processing related to operation recognition and display control is executed when the processor executes a control program stored in the memory. In addition, jobs related to reading of a document, printing of an image, and the like, that is, processing related to a series of image processing is executed. In other words, a function as the controller 11 that controls the multifunction peripheral 100 is implemented by cooperation of software resources and the hardware resources.

The communicator 11C provided in the controller 11 controls communication with an external device via a network. Examples of the external device are a PC, a tablet computer, and a mobile phone. However, the external device is not limited to any of these. FIG. 1 illustrates, as one of the external devices, a PC 110 that is used by a user for a remote scan job. The PC 110 is a personal computer and serves as a host of a remote scan in this embodiment.

The operation controller 11U provided in the controller 11 is connected to the operation acceptor 19, recognizes the user operation accepted by the operation acceptor 19, and generates display data to be displayed on the operation acceptor 19.

As illustrated in FIG. 2, the operation acceptor 19 is provided on a front side of the multifunction peripheral 100. The operation acceptor 19 has a display device that displays an operation screen generated by the operation controller 11U. Furthermore, the operation acceptor 19 has an operation detection device that accepts an instruction from the user on the operation screen. For example, a liquid-crystal display device or an organic light emitting display (OLED) is applicable as the display device. A touch panel is applicable as the operation detection device. The operation controller 11U communicates with the above-described operation detection device to recognize the user operation detected by the operation detection device, that is, the instruction from the user. In addition, the operation controller 11U sends the display data to the above-described display device and causes the display device to display the display data as the operation screen.

The image processor 11P provided in the controller 11 generates image data of the document on the basis of a read image signal that is output from the document reader 15. The generated document image data is sent to the external device via the communicator 11C in the case of a scan job.

In the remote scan job in this embodiment, the generated document image data is sent to the PC 110 as the host via the communicator 11C. In the case of a copy job, the generated document image data is sent to and printed by the printer 14. In addition, the image processor 11P generates image data for printing on the basis of job data of a print job that is received from the external device via the communicator 11C. The generated image data for printing is sent to and printed by the printer 14.

The job controller 11J provided in the controller 11 receives the instruction from the user, which is recognized by the operation controller 11U, and an instruction from the PC 110 as the host, which is received by the communicator 11C. In the case where the received instruction is related to a job setting, the job controller 11J updates such a setting. In the case where the job setting is associated with update of the operation screen, the operation controller 11U generates the display data of the updated operation screen and sends the display data to the display device in the operation acceptor 19. In this way, the operation screen is updated.

When receiving an instruction related to execution of the job, the job controller 11J controls the document reader 15, the printer 14, and the image processor 11P according to a type of the received job (for example, the scan job, the copy job, or the print job), and controls a flow of the image data to execute the instructed job.

In detail, the job controller 11J recognizes a state detected by a sensor, which is not illustrated and arranged in each of the document reader 15 and the printer 14. Then, the job controller 11J controls operation of a motor, an actuator, a device, and the like, each of which is not illustrated and arranged in each of the document reader 15 and the printer 14. In addition, the job controller 11J controls the image-related processing by the image processor 11P.

The storage device 13 includes one or both of non-volatile memory, such as a hard disk drive (HDD) or a solid-state drive (SSD), and volatile memory, such as dynamic random-access memory (DRAM), for storing the image data. In FIG. 1, the storage device 13 is illustrated to be in a different block from that of the controller 11. However, such an aspect can also be adopted that the storage device 13 is included in the block of the controller 11. That is, such an aspect can also be adopted that the storage device 13 is mounted on the same circuit board as the controller 11.

The document reader 15 reads the document image under the control by the job controller 11J, and converts the read document image into an RGB (red, green, blue) color image signal (an RGB analog signal). That is, the document reader 15 executes image reading processing in the copy job and the scan job. The user sets the document to be read in a document transport unit 16 illustrated in FIG. 2 or on a document table 17 illustrated in FIG. 3. The document table 17 is formed of a flat transparent glass member. The document reader includes an image sensor (not illustrated in FIG. 1 to FIG. 3). The document reader 15 also includes a scan mechanism (not illustrated in FIG. 1 to FIG. 3) for scanning the document that is placed on the document table 17.

The image processor 11P generates the document image data on the basis of the read image signal that is read by the image sensor. In addition, the image processor 11P generates the image data for printing on the basis of print data that is received from the external device via the communicator 11C. The generated image data is sent to and printed by the printer 14, or is sent to the external device via the communicator 11C.

The printer 14 feeds print sheets one by one from a paper tray (not illustrated in FIG. 1 to FIG. 3) that accommodates the print sheets, prints the image on each of the fed print sheets, and outputs the printed print sheets to a discharge tray. As illustrated in FIGS. 2 and 3, in the multifunction peripheral 100, the printed print sheet is discharged to one of three discharge trays 18a, 18b, 18c.

Basic Flow of Remote Scan Job

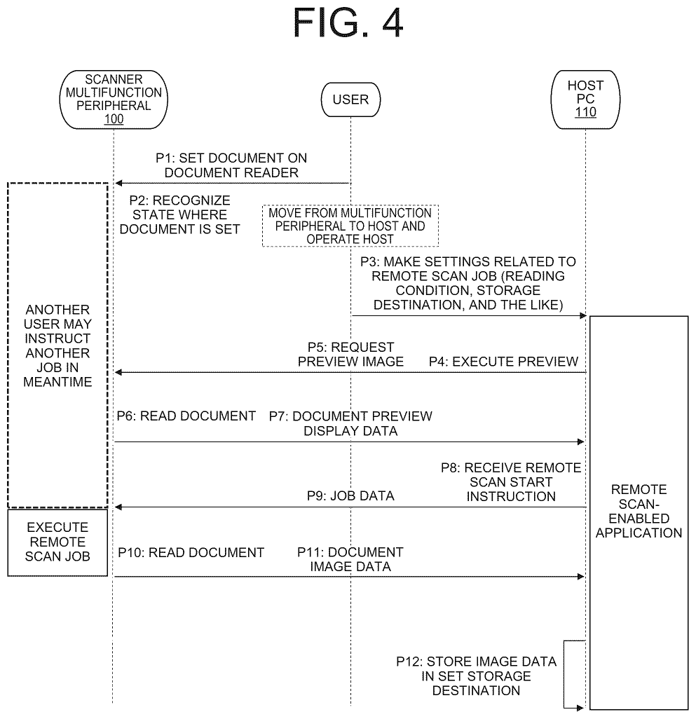

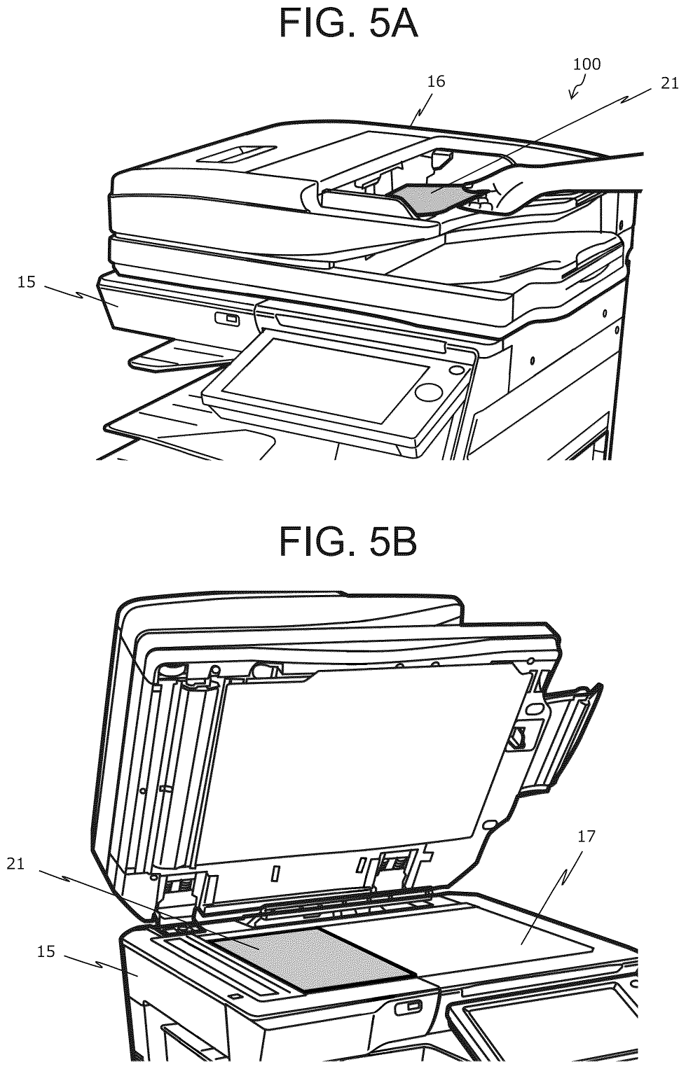

Next, a description will be made on a flow of the remote scan job according to the present disclosure. FIG. 4 is an explanatory chart illustrating an example of an operation and communication flow at the time when the multifunction peripheral according to this embodiment executes the remote scan job. As illustrated in FIG. 4, when the remote scan job is executed, the user first sets the document to be read by the multifunction peripheral 100 in the document transport unit 16 or on the document table 17 (see phase P1 in FIG. 4). FIG. 5A is an explanatory view illustrating a situation where a document 21 is set in the document transport unit 16 of the multifunction peripheral 100. FIG. 5B is an explanatory view illustrating a state where the document 21 is set on the document table 17 of the multifunction peripheral 100.

When the document 21 is set in the document transport unit 16 or on the document table 17, the sensor of the document reader 15 detects setting and a size of the document 21. The job controller 11J recognizes a document set state (see P2 in FIG. 4).

Then, the user moves from the multifunction peripheral 100 to the PC 110 as the host, then starts an image reading application related to the remote scan job on the multifunction peripheral 100, and selects the multifunction peripheral 100 as an image reading scanner. It is assumed that the application and a scanner driver for the multifunction peripheral 100 are installed in the PC 110 in advance.

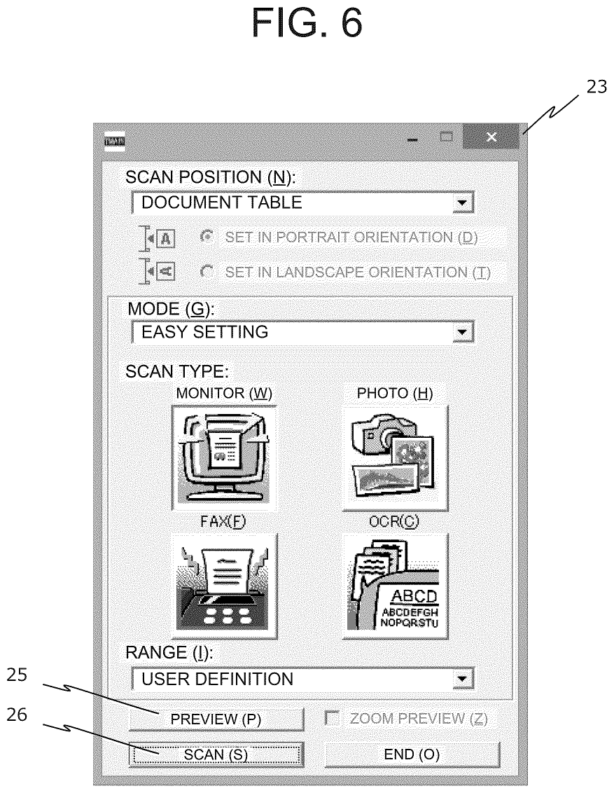

FIG. 6 is an explanatory view illustrating an example of a scanner driver screen related to the remote scan job that is displayed on a screen of the PC 110. In a “SCAN POSITION” menu of a scanner driver screen 23 illustrated in FIG. 6, the user selects whether the document 21 is set in the document transport unit 16 or is set on the document table 17. In a “MODE” menu of the scanner driver screen 23, a setting for reading is selected (see P3 in FIG. 4). In the “SIMPLE SETTING” illustrated in FIG. 6, any one of “MONITOR”, “PHOTO”, “FAX”, and “OCR” is selected according to a type or application of the document. “MONITOR” is a setting for application to view the read image on a monitor of the PC or the like. “PHOTO” is a setting for application to print or display a photo. “FAX” is a setting for application to send a facsimile. “OCR” is a setting for application to subject the read image to character recognition processing and extract characters in the document. In addition to “SIMPLE SETTING”, the user can select “ADVANCED SETTING”, which is not illustrated in FIG. 6. In “ADVANCED SETTING”, image quality, resolution, and the like can be set in detail.

In a “RANGE” menu on the scanner driver screen 23, the user can set a document reading range. In the case of “USER DEFINITION”, the reading range can be set on a scanner driver screen 27 for a preview, which will be described below. In addition to “USER DEFINITION”, the user can select “AUTO”, which is not illustrated in FIG. 6. In “AUTO”, the document is read in the size that is detected by the document reader 15.

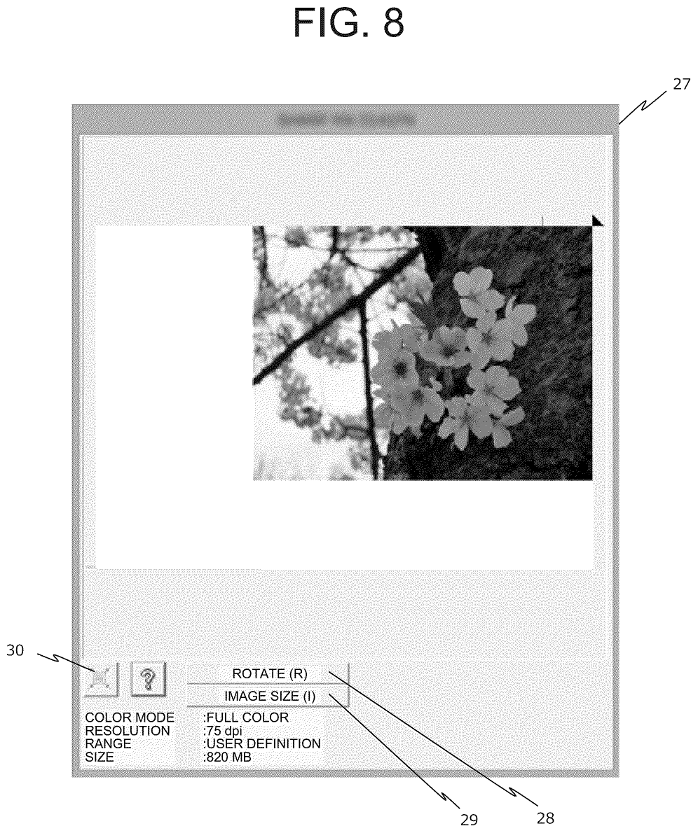

When a [PREVIEW] button 25 on a lower side is clicked (see P4 in FIG. 4), the document is read for the preview, and the scanner driver screen 27 for the preview illustrated in FIG. 8 is displayed instead of the scanner driver screen 23. Every time the preview is displayed, a scan instruction for displaying the preview is sent from the PC 110 to the multifunction peripheral 100 (see P5 in FIG. 4). Then, in response to the instruction, the multifunction peripheral 100 reads the document (see P6 in FIG. 4) and sends image data for the preview display to the PC 110 (see P7 in FIG. 4). FIG. 4 illustrates the preview displayed once and interaction performed at the time.

When a [SCAN] button 26 under the [PREVIEW] button 25 is clicked (see P8 in FIG. 4), the job data related to the remote scan job is sent from the PC 110 to the multifunction peripheral 100 (see P9 in FIG. 4). The job data contains information on the settings that are made on the scanner driver screens 23, 27. The job data can be considered as a job start instruction. When receiving the job data, the job controller 11J starts a pull scan job. Then, the job controller 11J reads the document on the basis of information on the settings contained in the job data (see P10 in FIG. 4). Thereafter, the job controller 11J sends the read image to the PC 110 (see P11 in FIG. 4). The user specifies a saving destination of the read image on the image reading application.

FIG. 8 is an explanatory view illustrating an example of the scanner driver screen 27 for the preview. As illustrated in FIG. 8, the preview of the read document image is displayed on the scanner driver screen 27. Every time a [ROTATE] button 28 on a lower side is clicked, the preview display rotates 90 degrees clockwise. When an [IMAGE SIZE] button 29 is clicked, a dialog box, which is not illustrated in FIG. 8, is displayed, and a reading range can be specified by inputting a numerical value in the dialog box.

When an auto range setting button 30 at a left end is clicked, the preview is displayed. Then, an entire previewed image is set as the reading range when the reading range is not specified. The PC 110 that has received the document image data from the multifunction peripheral 100 stores the image data in a storage destination set by using the image reading application (see P12 in FIG. 4).

The description has been made so far on the basic flow of the remote scan illustrated in FIG. 4.

A problem that possibly occurs at the time of executing the remote scan job is that, in a period from setting of the document in the document reader 15 to reception of the job data from the PC 110, another user who is unaware of the remote scan job walks up to the multifunction peripheral 100 and starts his/her job. For the remote scan, after setting the document in the document reader 15, the user moves from the multifunction peripheral 100 to the PC 110 and operates the application. In the case where the PC 110 is located away from the multifunction peripheral 100, the other user who walks up to the multifunction peripheral 100 later possibly misinterprets that the set document 21 is misplaced. Alternatively, there is a possibility that, since the document set on the document table 17 is hidden in the closed document transport unit 16, the other user does not notice the document.

A period in which the other user who walks up to the multifunction peripheral 100 possibly starts another job is indicated by a bold chain-line rectangle in FIG. 4.

Basic Flow of Push Scan Job Compared to the remote scan, in the case of a push scan that is executed by the user operating the operation acceptor 19, there is a low possibility that the other user walks up to the multifunction peripheral 100 and starts his/her job in the middle of setting for the push scan. A description will herein be made on a difference from the remote scan.

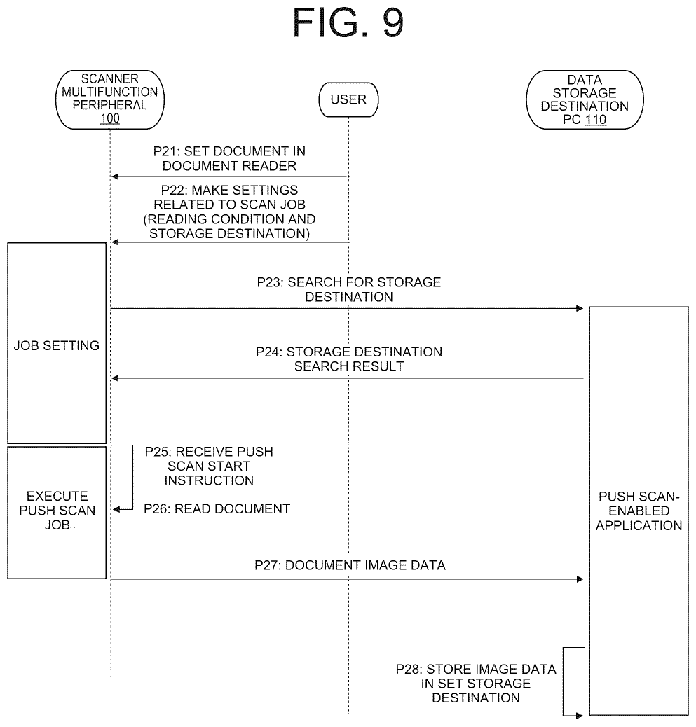

FIG. 9 is an explanatory chart illustrating an example of an operation and communication flow at the time when the multifunction peripheral 100 executes the push scan. FIG. 9 corresponds to the remote scan in FIG. 4.

In the case of the push scan, the user first sets the document in the document reader 15 (see P21 in FIG. 9) and then makes the setting related to a push scan job by using the operation acceptor 19 of the multifunction peripheral 100 (see P22 in FIG. 9). In the case of the push scan, the storage destination of the image data of the read document is also set by using the operation acceptor 19. A description will be made on, as an example, a case where the same PC 110 as that in FIG. 4 is selected as the storage destination of the image data.

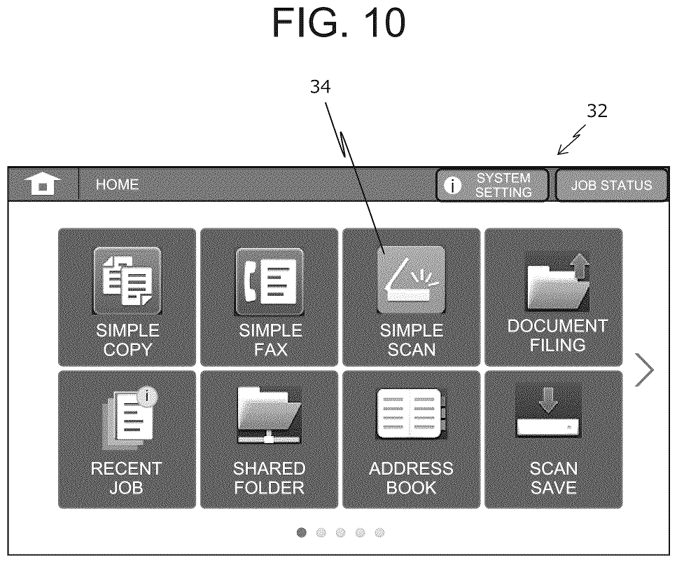

FIG. 10 is an explanatory view illustrating an example of a home screen, on which the user selects the desired job to be executed, as an example of the screen that is displayed on the operation acceptor 19 by the operation controller 11U. A total of eight operation buttons in two columns and four rows is displayed on a home screen 32 illustrated in FIG. 10. Each of “SIMPLE COPY”, “SIMPLE FAX”, “SIMPLE SCAN”, and “DOCUMENT FILING” arranged in an upper row is a job option. In this order, the job options are the copy job, a fax send job, the push scan job, and the print job of the image data saved (filed) in the storage device 13. Of the four buttons arranged in the lower row, “RECENT JOB” at a left end is used to display history of the executed jobs and accept re-execution in the same setting. “SHARED FOLDER” to the right is the print job to print the image data that is stored in “SHARED FOLDER” of the storage device 13. In “ADDRESS BOOK”, the destinations for the push scan job and the fax send job are registered and edited. “SCAN SAVE” is a job to read the document and store the image data in the storage device 13 or an external memory device such as a USB flash drive.

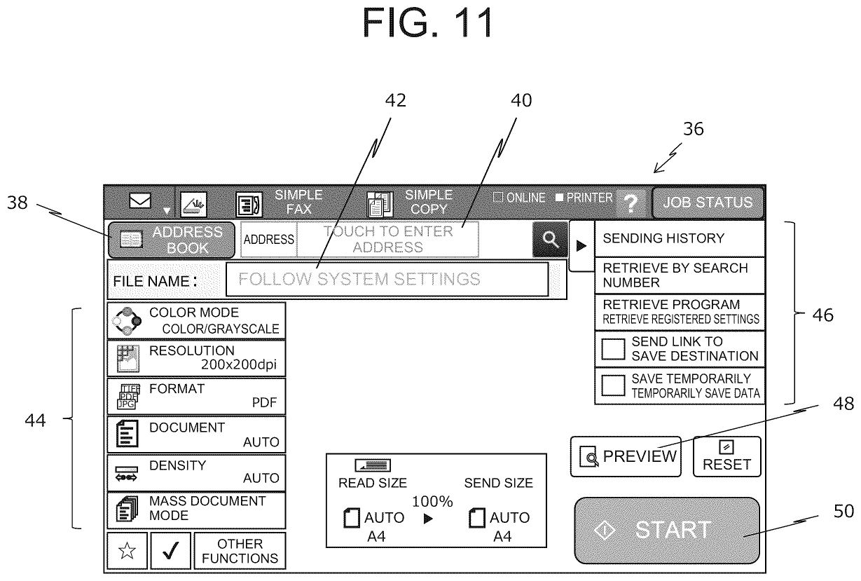

When the user touches a simple scan button 34, the operation controller 11U switches the home screen 32 to a scan job screen 36 illustrated in FIG. 11. On the scan job screen 36, an address book button 38, a destination input field 40, and a file name input field 42 are arranged in an upper portion. The address book button 38 is used to retrieve an address book. The destination input field 40 accepts direct input or selection of the destination. The file name input field 42 accepts input of a file name at the time of storing the image data.

A storage destination device and a storage destination folder related to the push scan job may be registered in advance in the address book that is stored in the storage device 13. However, such an aspect is also considered that the storage destination device and the storage destination folder are input each time by using the destination input field 40 of the scan job screen 36 or that candidates therefor are searched each time. FIG. 9 illustrates an example in which, when the user touches the destination input field 40, a storage destination search (see P23 in FIG. 9) is output from the multifunction peripheral 100 on the basis of such an operation and the device that can respond thereto provides a storage destination search result (see P24 in FIG. 9). It is assumed that a push scan-enabled application is installed in advance in the device that can respond (the PC 110 in the example illustrated in FIG. 9). Such an application responds to the storage destination search with the storage destination search result. The multifunction peripheral 100 that has received the storage destination search result from the device that can respond displays the search result on an unillustrated dialog screen. Then, the user selects the storage destination from the storage destination candidates displayed on the dialog screen.

The description will now return to the scan job screen 36. Plural setting keys 44, each of which accepts a setting related to reading, are arranged in a left end portion of the screen. An action panel 46 is arranged in a right end portion of the screen to display at least one operation button, which is changed according to a status or the setting, and accept the user operation.

A preview button 48 is used to read the document and display a preview display screen, which is not illustrated, in the operation acceptor 19. The preview button 48 can be considered as a button that has a function corresponding to the [PREVIEW] button 25 for the remote scan. A start button 50 is used to start the push scan job. The start button 50 can be considered as a button that has a function corresponding to the [SCAN] button 26 for the remote scan.

When the start button 50 is touched, the job controller 11J recognizes such an operation (see P25 in FIG. 9) and controls the document reader 15 to read the document (see P26 in FIG. 9). Then, the job controller 11J sends the document image data to the device as the destination that has been selected from the address book or the destination that has been input in or selected from the destination input field 40 (see P27 in FIG. 9). At the time, the job controller 11J adds information on the destination (the folder name of the save destination, the file name to be saved, and the like) to the image data.

In the PC 110 that has received the document image, the push scan-enabled application stores the image data in the storage destination on the basis of the added information (see P28 in FIG. 9).

The description has been made so far on the basic flow of the push scan illustrated in FIG. 9.

In the case of the push scan, differing from the remote scan, the user makes the setting related to the push scan job by using the operation acceptor 19 of the multifunction peripheral 100, in which the user sets the document in the document reader 15 (see a rectangle “JOB SETTING” at a left end in FIG. 9). Accordingly, it can be said that, even in the case where the other user walks up to the multifunction peripheral 100 before the execution of the push scan job is started, the other user is highly likely to wait for the termination of the push scan job and then starts his/her job.

Thus, a problem at the time of the remote scan is how to prevent confusion between the remote scan job and the other job without causing any hassle in the period from setting of the document to the start of the remote scan job.

Mode to Prevent Confusion Between Remote Scan Job and Other Jobs

To handle such a problem, in this embodiment, in the case where the operation acceptor 19 of the multifunction peripheral 100 is operated in a state where the document is set, the job data related to the remote scan job is not accepted until a predetermined period elapses from time at which the operation is performed. That is, a job for which the setting and the execution instruction are made via the operation acceptor 19 (also referred to as a walk-up job) is prioritized over the remote scan job.

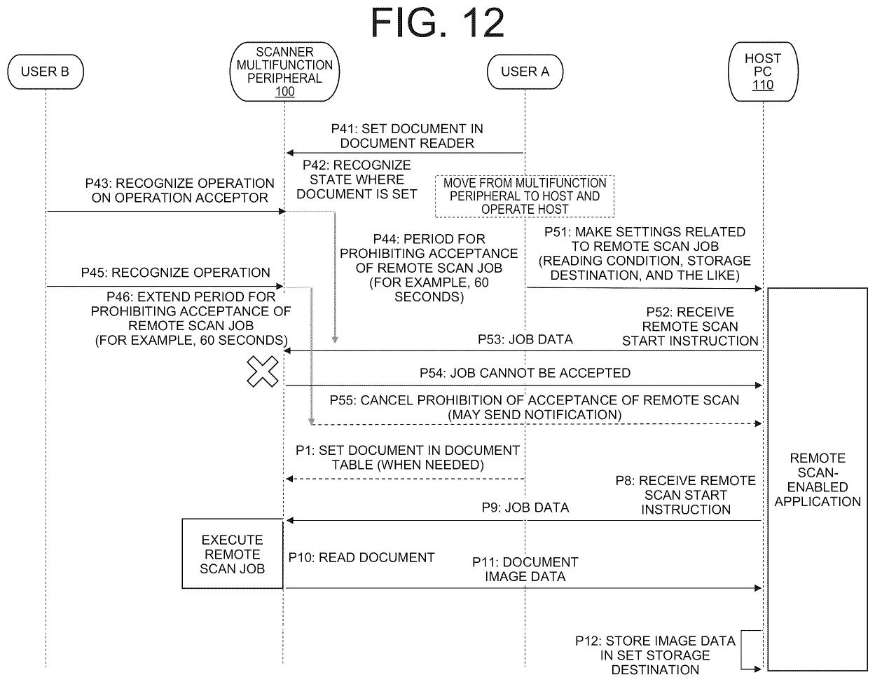

FIG. 12 is an explanatory chart illustrating an example of processing to prevent confusion between the remote scan job and the other job in this embodiment.

In FIG. 12, a user A is a user who executes the remote scan job, and a user B is a user (a walk-up user) who executes another walk-up job (for example, the copy job).

It is assumed that the user A sets the document in the document reader 15 (see P41 in FIG. 12) and, in a state where the job controller 11J recognizes setting of the document (see P42 in FIG. 12), the user A moves from the multifunction peripheral 100 to the PC 110 as the host and operates the PC 110 (see P51 in FIG. 12).

In the meantime, the user B walks up to the multifunction peripheral 100 and operates the operation acceptor 19. Then, the operation controller 11U recognizes such an operation (see P43 in FIG. 12). In such a case, even when receiving the job data for the remote scan job from the external device, the job controller 11J executes control not to accept the job data for the remote scan job from the external device for a predetermined period (60 seconds herein as an example) from time at which the operation on the operation acceptor 19 is recognized (see P44 in FIG. 12). The predetermined period may be settable or changeable by the user within a range from 30 seconds to 120 seconds, for example.

In addition, as illustrated in FIG. 12, in the case where the operation controller 11U recognizes that the next operation is performed before a lapse of 60 seconds (may be settable appropriately as described above) as the predetermined period from the certain operation (see P45 in FIG. 12), the job controller 11J extends the period for prohibiting the acceptance of the remote scan job. In other words, the job controller 11J updates the setting of the period so as not to accept the job data for the remote scan job for the predetermined period (60 seconds) starting from such a time point (see P46 in FIG. 12).

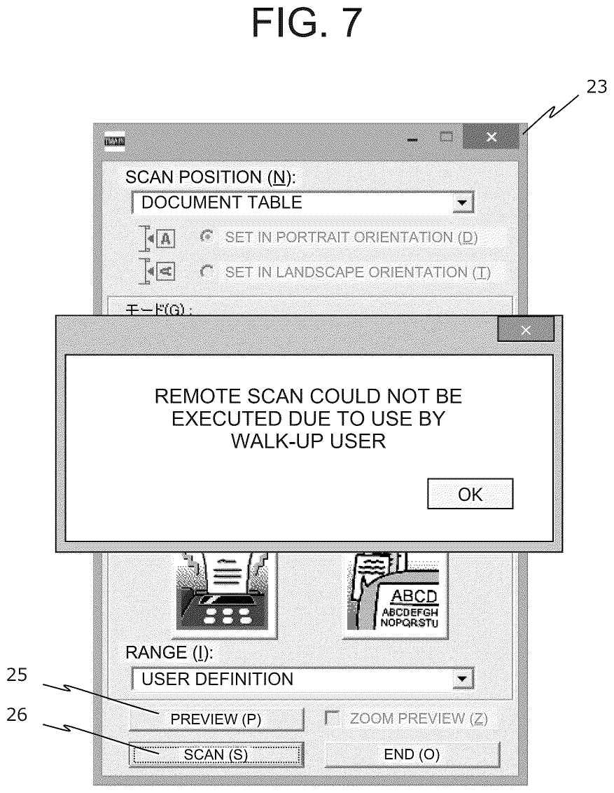

It is assumed that the user A clicks the [SCAN] button 26 on the scanner driver screen 23 during the period in which the multifunction peripheral 100 does not accept the remote scan job (see P52 in FIG. 12). The application on the PC 110 sends the job data related to the remote scan job to the multifunction peripheral 100 (see P53 in FIG. 12). In the multifunction peripheral 100, the job controller 11J recognizes the reception of the job data. However, since it is in the middle of the period in which the job data related to the remote scan job is not accepted, the job controller 11J replies to the PC 110 with a response that the job cannot be accepted (see P54 in FIG. 12), and does not execute the remote scan job. Preferably, the application on the PC 110 displays that the multifunction peripheral 100 is in a job acceptance prohibition state, and notifies the user A of such a state (see FIG. 7).

In the case where the further operation is not performed on the operation acceptor 19 and the predetermined period (60 seconds) elapses, the job controller 11J cancels the remote scan job acceptance prohibition state (see P55 in FIG. 12). The job controller 11J may notify the PC 110 that the remote scan job acceptance prohibition state has been canceled. The state where the prohibition of the acceptance of the remote scan job is canceled is the same as that in FIG. 4. When the user A clicks the [SCAN] button 26 again, the processing proceeds as in FIG. 4. In FIG. 12, the same processing as that in FIG. 4 is denoted by the same phase (P8 to P12).

In the example illustrated in FIG. 12, while the user B operates the operation acceptor 19, the user B does not replace the set document with his/her document to execute his/her job. Accordingly, at the time point of P55 at which the prohibition of the acceptance of the remote scan job is canceled, the document set by the user A (see P41) remains as is, and thus the user A does not have to set the document again. However, in the case where the user B has removed the set document, the user A has to set the document in the multifunction peripheral 100 again before executing the remote scan job. Phase P1 indicated by a chain line in FIG. 12 indicates timing to set the document again by the user A in such a case.

According to this embodiment, in the predetermined period from the time at which the user B operates the operation acceptor 19, the multifunction peripheral 100 is in the remote scan job acceptance prohibition state. Even when the user A instructs to execute the remote scan job in such a state, the remote scan job is not executed. Thus, the user A can easily notice that the user B is operating the multifunction peripheral 100. In this way, it is possible to prevent confusion between the remote scan job and the other job.

Regarding Initial Operation Screen

As described above with reference to FIG. 12, when accepting the operation on the operation acceptor 19, the job controller 11J uses such an operation as a trigger to set the remote scan job acceptance prohibition state for the predetermined period. In other words, in the case where the job data related to the pull scan job is received from the external device, whether to accept the pull scan job is not determined on the basis of a relationship with the operation screen displayed at the time. A description will herein be made on an advantage of such a point.

In this embodiment, the operation controller 11U displays a specific initial operation screen with any of the following cases being a trigger. The cases are power-on of the multifunction peripheral 100, return of the multifunction peripheral 100 from a power saving state to a normal standby state, and the time-out at which a predetermined period elapses with no operation being performed. The predetermined period may be settable or changeable by the user within the range from 30 seconds to 120 seconds, for example. The initial operation screen is the operation screen that is selected by the user in advance from the various operation screens displayed on the operation acceptor 19 by the operation controller 11U. For example, in the case where the push scan job is frequently used, the user preferably sets the scan job screen 36 illustrated in FIG. 11 as the initial operation screen. In the case where the power-on of the multifunction peripheral 100, return of the multifunction peripheral 100 from a power saving mode, or the time-out occurs, the operation controller 11U executes control to display the home screen 32 on the operation acceptor 19 with occurrence of any of those events being a trigger. The initial operation screen is not limited to the home screen 32. A user-friendly screen, such as the home screen 32 illustrated in FIG. 10, can be set as the initial operation screen.

Here, it is assumed that the scan job screen 36 is set as the initial operation screen. The scan job screen 36 is the screen on which the setting and the execution instruction related to the push scan job, which differs from the pull scan job, are made. In the standby state where the multifunction peripheral 100 terminates the execution of the job and waits for the next job, the initial operation screen is mostly displayed as the operation screen on the operation acceptor 19.

It is considered to whether to accept the pull scan job in the case where the job controller 11J receives the job data related to the pull scan job while the initial operation screen is displayed. In the case where the job controller 11J determines whether to accept the pull scan job on the basis of the relationship with the operation screen displayed on the operation acceptor 19 at the time of receiving the job data related to the pull scan job, the initial operation screen that is displayed at the time is the scan job screen 36. The scan job screen 36 is the operation screen on which the setting and the execution instruction of the push scan job, which cannot be executed in parallel with the pull scan job, are made. Thus, from the relationship with the displayed initial operation screen, the job controller 11J determines the acceptance prohibition state.

However, according to this embodiment, even in the case where the scan job screen 36 is displayed as the initial operation screen, the job controller 11J determines that the pull scan job can be accepted unless the operation on the scan job screen 36 is performed. Furthermore, even in the case where the operation on the scan job screen 36 is performed, the job controller 11J determines that the pull scan job can be accepted when the last job is performed before the predetermined period. When such a case is applied to the example illustrated in FIG. 12, the acceptance prohibition state of the remote scan job is not determined only for a reason that the initial operation screen is displayed regardless of the user A's intention.

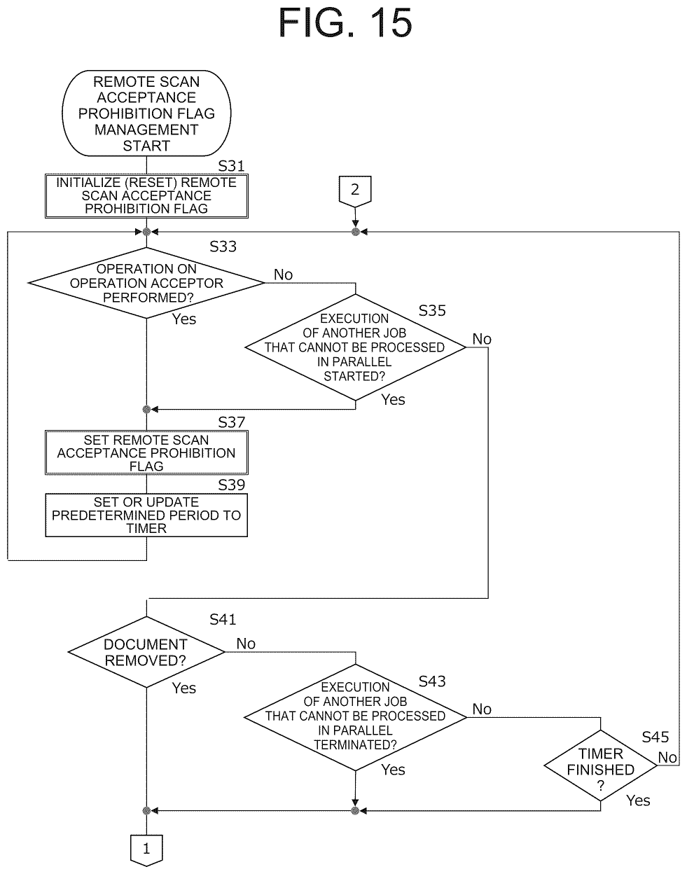

Furthermore, in the case where the initial operation screen is displayed on the operation acceptor 19 on the basis of the occurrence of the time-out event in which the predetermined period elapses with no operation being performed, processing in steps S37, S39 illustrated in FIG. 15 is not executed in association therewith by a remote scan acceptance prohibition flag management task. The time-out is not the event that occurs on the basis of the user operation but rather the event that occurs due to a lack of the operation. Thus, the acceptance prohibition state of the remote scan job is not set.

### Second Embodiment

In the first embodiment, the description has been made on the case where the user B operates the operation acceptor 19 while the user A attempts to execute the remote scan job. In this embodiment, a description will be made on a case where the user B not only operates the operation acceptor 19 but also replaces the set document with his/her document to execute his/her job.

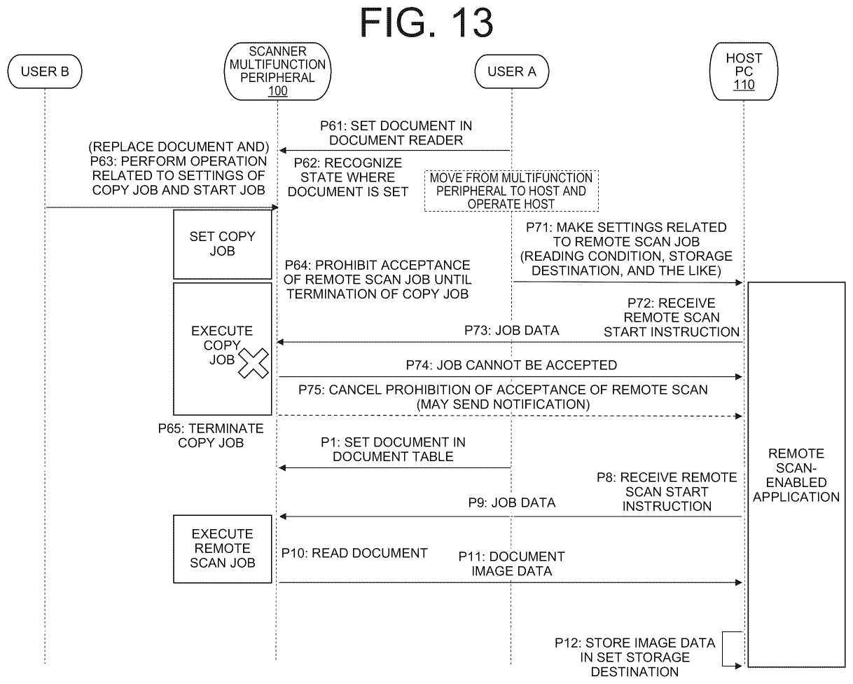

FIG. 13 is an explanatory chart illustrating an example of processing to prevent confusion between the remote scan job and the other job in this embodiment.

The user A sets the document in the document reader 15 (see P61 in FIG. 13). Then, in the state where the job controller 11J recognizes setting of the document (see P62 in FIG. 13), the user A moves from the multifunction peripheral 100 to the PC 110 as the host and operates the PC 110 (see P71 in FIG. 13). The processing so far is the same as that in the first embodiment.

In the meantime, the user B who walks up to the multifunction peripheral 100 not only operates the operation acceptor 19, but also replaces the set document with his/her document, performs an operation related to the setting of the copy job, and starts the copy job (see P63 in FIG. 13). The job controller 11J sets the acceptance prohibition state of the remote scan job for the predetermined period from the setting operation. When the operation continues, the period for prohibiting the acceptance of the remote scan job is extended. Such a case is the same as that in the first embodiment. Next, when the start of the copy job is instructed, the job controller 11J sets the acceptance prohibition state of the remote scan job, for which the same document reader 15 is used, until the copy job is terminated (see P64 in FIG. 13).

Then, in the state where the multifunction peripheral 100 prohibits the acceptance of the remote scan job, the user A clicks the [SCAN] button 26 on the scanner driver screen 23 (see P72 in FIG. 13). The application on the PC 110 sends the job data related to the remote scan job to the multifunction peripheral 100 (see P73 in FIG. 13). In the multifunction peripheral 100, the job controller 11J recognizes the reception of the job data. However, since it is in the middle of the period in which the job data related to the remote scan job is not accepted, the job controller 11J replies to the PC 110 with the response that the job cannot be accepted (see P74 in FIG. 13), and thus does not execute the remote scan job. Preferably, the application on the PC 110 displays that the multifunction peripheral 100 is in the job acceptance prohibition state, and notifies the user A of such a state.

When the copy job is terminated (see P65 in FIG. 13), the job controller 11J cancels the acceptance prohibition state of the remote scan job (see P75 in FIG. 13). The job controller 11J may notify the PC 110 that the remote scan job acceptance prohibition state has been canceled.

The state where the prohibition of the acceptance of the remote scan job is canceled is the same as that in FIG. 4. However, the document set by the user A has been removed by the user B. Thus, the user A has to set the document in the multifunction peripheral 100 again to execute the remote scan job. Phase P1 illustrated in FIG. 13 indicates that the user A sets the document again.

When the user A sets the document again and clicks the [SCAN] button 26 again, the processing proceeds as in FIG. 4. In FIG. 12, the same processing as that in FIG. 4 is denoted by the same phase (P8 to P12).

According to this embodiment, in the period from the start of the setting operation related to the other job by the user B to the termination of such a job, the acceptance of the remote scan job is prohibited. The remote scan job is not executed in such a state even when the user A instructs the execution of the remote scan job. Thus, the user A can easily notice that the user B is operating the multifunction peripheral 100. In this way, it is possible to prevent the confusion between the remote scan job and the other job.

Flowchart

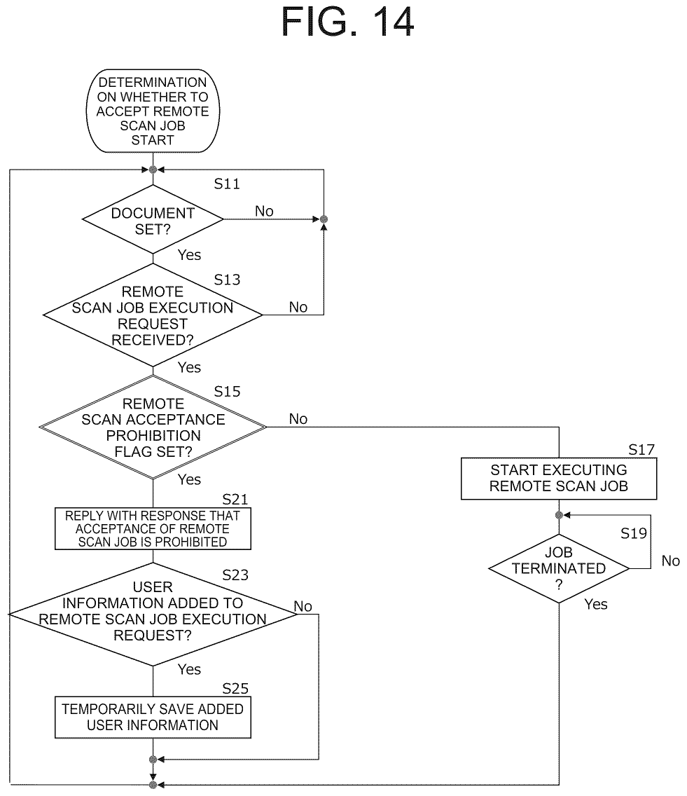

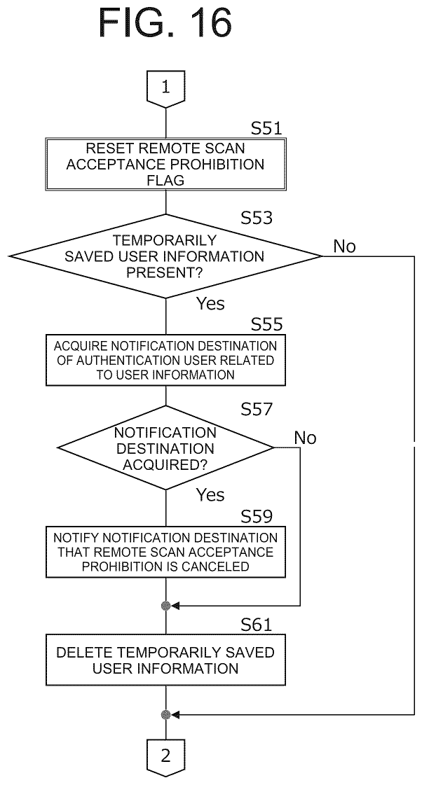

A description will hereinafter be made on an example of processing in which the controller 11 executes the processing in the first and second embodiments with reference to flowcharts. FIG. 14 to FIG. 16 are flowcharts illustrating the example of the processing executed by the controller 11. FIG. 14 is related to processing to determine whether to accept the remote scan job. FIG. 15 and FIG. 16 are related to processing to manage a remote scan acceptance prohibition flag. Both of the processing related to the determination on whether to accept the remote scan job and the processing related to the management of the remote scan acceptance prohibition flag belong to the job controller 11J. In addition to those, the processor of the controller 11 executes plural types of processing belonging to the communicator 11C, the job controller 11J, the image processor 11P, and the operation controller 11U in parallel as tasks under multitasking environment.

In regard to the task related to the determination on whether to accept the remote scan job, which is illustrated in FIG. 14, in P53 and P9 illustrated in FIGS. 12 and P73 and P9 illustrated in FIG. 13, it is determined whether to execute the remote scan job in the case where the job data is received from the PC 110. Whether the multifunction peripheral 100 is in the remote scan job acceptable state or the remote scan job acceptance prohibition state is determined with reference to the remote scan acceptance prohibition flag (see step S15 illustrated in FIG. 14). The remote scan acceptance prohibition flag is secured as a single static variable in the memory of the controller 11, and is managed by a remote scan acceptance prohibition management task illustrated in FIG. 15 and FIG. 16.

The processor that executes the task related to the determination on whether to accept the remote scan job illustrated in FIG. 14 waits until the document is set in the document transport unit 16 or on the document table 17 of the document reader 15 (a loop of No in step S11). Once the document is set (Yes in step S11), the processor then waits until receiving the job data related to the remote scan job (a loop of No in step S13).

When receiving the job data related to the remote scan job in the document set state (Yes in step S13), the processor that executes the task refers to the above-described remote scan acceptance prohibition flag (step S15).

If the remote scan acceptance prohibition flag is reset (No in step S15), such a case indicates that the remote scan can be accepted. Accordingly, the processor that executes the task instructs the task, which is not illustrated and, as the job controller 11J, controls the execution of the remote scan job, to start the remote scan job (step S17). The task that receives the instruction executes the remote scan job, controls the document reader 15 to read the set document, and sends the image data of the read document to the device as the sending source of the job data (see P9 to P11 illustrated in FIGS. 4, 12, and 13).

The processor that executes the task related to the determination on whether to accept the remote scan job waits until the remote scan job is terminated (step S19). Then, the processing returns to step S11 described above. Thereafter, the processor waits until the next document is set and the job data related to the remote scan job is received.

On the other hand, if it is determined in step S15 described above that the remote scan acceptance prohibition flag is set (Yes in step S15), such a determination indicates the acceptance prohibition state of the remote scan job. In such a case, the processor that executes the task replies to the device, which has sent the job data, (the PC 110 in the case of FIGS. 4, 12, and 13) with a response that the remote scan job cannot be accepted (step S21). This corresponds to P54 in FIGS. 12 and P74 in FIG. 13.

In the example illustrated in FIG. 14, it is determined whether user information is added to the further received job data of the remote scan job (step S23). In this example, the multifunction peripheral 100 has a user authentication function.

When executing the job such as the remote scan job, the user can use the user authentication function. The user can also execute the job as a guest without using the user authentication function. The determination in step S23 is made to determine whether the remote scan job is executed by using the user authentication function.

Although not illustrated in FIG. 4, a procedure for user authentication is executed as follows, for example. The user who attempts to execute the remote scan job by using the user authentication function of the multifunction peripheral 100 inputs user authentication information into the remote scan job-enabled application on the PC 110 when activating the application. An example of the user authentication information is a user ID and a password. Meanwhile, the user information on the authenticated user who is permitted to use the multifunction peripheral 100 is registered in advance in the storage device 13 of the multifunction peripheral 100. The user information contains the user authentication information, a mail address, to which the notification is sent to the user, and the like.

The application that accepts the input of the user authentication information adds the user authentication information to a preview image request (see P5 in FIG. 4) and the job data (see P9 in FIG. 4), and sends the preview image request and the job data to the multifunction peripheral 100. In the multifunction peripheral 100 that has received the preview image request and the job data, each of which contains the user authentication information, the job controller 11J passes the received user authentication information to an authentication task that processes the user authentication, and causes the authentication task to execute the user authentication. The authentication task matches the user authentication information received from the PC 110 against the user authentication information of the authentication user who is registered in the storage device 13. Then, in the case where no match is found, the authentication task replies with an authentication error. The job controller 11J sends, as the response, the authentication error to the PC 110. On the other hand, in the case where the user authentication information received from the PC 110 matches the user authentication information of any of the registered authentication users, the preview image request or the remote scan job instruction is sent from the authentication user. Then, the job controller 11J responds as described in FIGS. 4, 12, and 13.

In the determination in step S23, if the user information is added to the job data of the remote scan job, the processor that executes the task determines that the received job data is instructed from the authentication user (Yes in step S21). In such a case, when the acceptance prohibition state of the remote scan job is canceled, the notification thereof is sent to the authentication user. Thus, the user information is temporarily stored. Here, the notification destination is registered in advance as one piece of the user information on the authentication users, and is stored in the storage device 13. Then, the processing returns to step S11 described above, the next document is set, and the job controller 11J wait until the job data related to the remote scan job is received.

On the other hand, in the determination in step S23, if the user information is not added to the job data of the remote scan job, it is determined that the received job data is executed by the guest without using the user authentication function. In such a case, since the notification destination to the user cannot be acquired, the user information is not stored. Then, the processing returns to step S11, and the job controller 11J waits for setting of the next document and reception of the job data.

The description has been made so far on the processing related to the determination on whether to accept the remote scan job.

Next, a description will be made on the remote scan acceptance prohibition flag management processing illustrated in FIG. 15 and FIG. 16.

As illustrated in FIG. 15, when the task is activated at the time of the power-on, the processor that executes the task resets the flag as initialization processing of the remote scan acceptance prohibition flag (step S31). Then, occurrence of an event to set the flag, and occurrence of an event to reset the flag are monitored.

As processing related to the occurrence of the event to set the flag, the processor that executes the task executes the following. First, it is determined whether any operation is performed on the operation acceptor 19 (step S33). If any operation is performed (Yes in step S33), the remote scan acceptance prohibition flag is set (step S37). Then, the predetermined period (60 seconds in the example illustrated in FIG. 12) is set to a timer (step S39), the processing returns to step S33 described above, and occurrence of the next event is monitored.

If the operation on the operation acceptor 19 is not detected in the determination in step S33 described above, then the processor that executes the task monitors the start of the other job (the copy job in the example illustrated in FIG. 13) that cannot be executed in parallel with the remote scan job (step S35). If the other job that cannot be executed in parallel is started (Yes in step S35), the processing proceeds to step S37 described above, the remote scan acceptance prohibition flag is set, the predetermined period is set to the timer, and the occurrence of the next event is monitored.

The description has been made so far on the processing to monitor the occurrence of the event to set the flag.

If the other job that cannot be executed in parallel is not started in step S35 (No in step S35), then the processing proceeds to step S41, and the processor that executes the task monitors the occurrence of the event to reset the flag.

In step S41, the processor that executes the task determines whether the document set in the document transport unit 16 or on the document table 17 is removed therefrom. If it is determined that the document is removed (Yes in step S41), the processing proceeds to step S51 in FIG. 16.

If the operation to remove the document is not detected (No in step S41), then the processor that executes the task monitors whether the other job that cannot be executed in parallel and is currently executed (the copy job in the example illustrated in FIG. 13) is terminated (step S43). If the other job that cannot be executed in parallel is terminated (Yes in step S43), the processing proceeds to step S45.

On the other hand, if the other job that cannot be executed in parallel is not terminated (No in step S41), then, the processor that executes the task monitors whether the timer set in step S39 described above is finished (step S45). If the timer is finished (Yes in step S45), the processing proceeds to step S51 in FIG. 16.

If the timer is not finished (No in step S45), the processing returns to step S33 described above, and the event to set or reset the flag is continuously monitored.

As described above, if any of the events to reset the remote scan acceptance prohibition flag occurs in the determination in step S41, S43, or S45, the processor that executes the task resets the remote scan acceptance prohibition flag (step S51 illustrated in FIG. 16).

Then, it is checked whether there is the user information that is temporarily saved in the processing in step S25 illustrated in FIG. 14 (step S53). If there is no user information that is temporarily saved, the processing returns to step S33 illustrated in FIG. 15, and the processor that executes the task continuously monitors the event to set or reset the flag.

On the other hand, if there is the user information that is temporarily saved (Yes in step S53), the processor that executes the task refers to the storage device 13 and acquires the notification destination that is registered for the authentication user corresponding to the user information (step S55). If the notification destination is acquired (Yes in step S57), such a notification that the acceptance prohibition state of the remote scan job is canceled is sent to the acquired notification destination (step S59). Then, the user information that is temporarily saved is deleted (step S61), the processing returns to step S33 illustrated in FIG. 15, and the processor that executes the task continuously monitors the event to set or reset the flag. In the determination in step S57 described above, if the notification destination cannot be acquired (No in step S57), the processing in step S59 is skipped, and the processing in step S61 is executed. The case where the notification destination cannot be acquired is a case where the notification destination of the authentication user is not registered.

The description has been made so far on the processing related to the remote scan acceptance prohibition management.

### Third Embodiment

In the first embodiment, the description has been made that, in the case where the operation is performed on the operation acceptor 19, the job controller 11J executes the control to set the acceptance prohibition state of the remote scan job for the predetermined period from such an operation, so as to prevent the confusion with the other job. However, in a particular case, the acceptance prohibition state of the remote scan job may not be set even when the operation on the operation acceptor 19 is performed. In this embodiment, a description will be made on an example of such an exceptional example.

For example, it is assumed that the operation is performed on the operation screen on which the address book or the authentication user is registered or edited and on the operation screen on which the operation to register the user destination or the information on the user in the multifunction peripheral 100 is accepted. In this case, it may be determined that such an operation differs from the operation for the setting related to the other job, and the job controller 11J may not set the acceptance prohibition state of the remote scan.

In addition, such an aspect can also be considered that, when the multifunction peripheral 100 is in the power saving mode, the operation screen is not displayed on the operation acceptor 19 for a purpose of reducing power consumption. A backlight is blacked out. Even in the case where the operation screen in the power saving mode is as described above, the job data related to the remote scan job can be accepted as long as the power is supplied to the controller 11 including the communicator 11C.

A state where the operation screen as an operation target is not displayed just as described may not be considered as a state where the setting operation and the execution operation related to the other job is accepted. In this way, the job data related to the remote scan job may be accepted.

Furthermore, the home screen 32, one example of which is illustrated in FIG. 10, may be provided with a button used to select the remote scan job. When the user selects the button for the remote scan job, the job controller 11J may start the remote scan job, and the operation controller 11U may display, on the operation acceptor 19, a remote scan screen indicating that the remote scan job is currently set or executed.

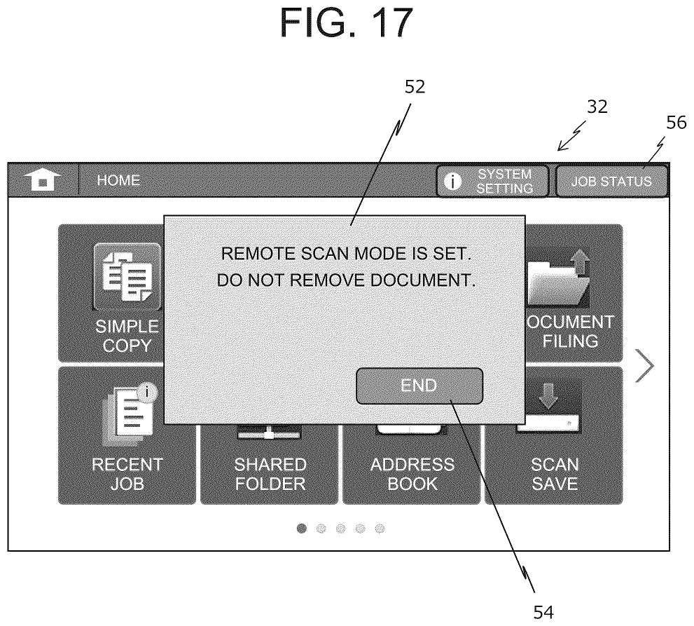

FIG. 17 is an explanatory view illustrating an example of the remote scan screen indicating that the remote scan job is currently set or executed in this embodiment. On a remote scan screen 52, only an [END] button 54 to terminate the display thereof is displayed, and any other button for accepting the operation is not provided.

When the user who executes the remote scan job selects the remote scan job on the home screen 32, the remote scan screen 52 is displayed. The user sets the document in the document transport unit 16 or on the document table 17, then moves to the host (the PC 110 in the example illustrated in FIG. 12), and instructs the execution of the remote scan job on the scanner driver screen 23.

As it has been described with reference to FIG. 12, at this stage, the user walks away from the multifunction peripheral 100 while the document remains set therein. However, the remote scan screen 52 indicating that the remote scan job is currently set or executed is displayed on the operation acceptor 19. Thus, even when the other user walks to the multifunction peripheral 100, the other user cannot set or execute the other job. After the remote scan job is terminated, the user who has executed the pull scan job moves to the multifunction peripheral 100 and collects the read document. When collecting the document, the user performs an operation to terminate the remote scan screen 52, so as to allow the other user to set and execute the other job. However, in the case where the user forgets to perform the operation to terminate the remote scan screen 52, the remote scan screen 52 may be terminated at the time-out at which the predetermined period elapses with no operation after the termination of the pull scan job.

In the case where the remote scan screen 52 is displayed to execute the remote scan job, the operation on the remote scan screen 52, that is, the operation of the [END] button 54 may not be used to set the acceptance prohibition state of the remote scan job as the setting operation and the execution operation related to the other job are not accepted.

Furthermore, the operation other than that for the [END] button 54 may be accepted on the operation screen, on which the remote scan screen 52 is displayed, as long as such an operation is not the operation related to setting of the other job. For example, in FIG. 17, a [JOB STATUS] button 56 is arranged at an upper right end. The job controller 11J may accept the operation of this [JOB STATUS] button 56. When the [JOB STATUS] button 56 is operated, the job controller 11J displays a list of the currently-executed job and the terminated jobs on the operation screen. However, operations for the listed job, such as to stop or delete the currently executed job and to switch an execution order, cannot be performed. This is because those operations are related to setting of the other job.

As it has been described so far,
(i) the image reading apparatus according to the present disclosure includes: the document reader that reads the image of the set document; the communicator that receives the instruction related to the execution of the remote scan job from the external device; the job controller that controls the document reader to read the document on the basis of the instruction and send the read image to the external device; and the operation acceptor that displays the operation screen and accepts the operation from the user via the displayed operation screen. When accepting the operation via the operation screen, the job controller determines that such an operation is the operation related to the job different from the remote scan job, and sets the state where the acceptance of the instruction related to the execution of the remote scan job is prohibited onward.

In the present disclosure, the image reader reads the document image and generates the image data. As a specific aspect thereof, examples of the image reader are: the image reader that transports the document and uses an image sensor to read the transported document; and the image reader that scans the document and uses the image sensor to read the document. The document transport unit in the above-described embodiment transports the document and causes the image sensor to read the document. The document table is used to place the document to be scanned thereon.

The remote scan is the scan job in which the external device as the host is used to make the setting related to reading of the document and give the instruction for reading, the image reading apparatus that receives the instruction reads the document set on the document table or in the document feeder and sends the read image to the host. The example of the basic interaction between the image reading apparatus and the host is as described in the above-described first embodiment and illustrated in FIG. 4.

Furthermore, the job is a series of the processing related to reading (scanning) of the image by the image reading apparatus. Since the multifunction peripheral in the embodiment has the print function in addition to the image reading function, the jobs that can be executed by the multifunction peripheral include not only the scan job but also the print job, the copy job, and the like, for example.

The communicator is hardware or software that is provided to the image reading apparatus for the communication with the external device, and any format or type thereof can be adopted.

The job controller executes the processing related to the execution and the control of the job. The job controller mainly includes the processor and the memory as the hardware resources, and the function thereof is implemented when the processor executes the control program stored in the memory. Furthermore, the operation acceptor accepts the user operation and causes the job controller to recognize the user operation. In addition, the operation acceptor presents the status of the multifunction peripheral or the job status to the user. Examples of the specific aspect of the operation acceptor are a display device such as a liquid-crystal display and the operation detection device such as the touch panel.

A description will further be made on preferred aspects of the present disclosure.
(ii) In the case where the new operation is not performed on the operation screen for the predetermined period since setting of the state where the acceptance of the instruction related to the execution of the remote screen job is prohibited, the job controller may set the remote scan job, the acceptance of which has been prohibited, to be acceptable.

According to this aspect, by accepting the operation on the operation screen, the job controller can set the remote scan job, the acceptance of which has been prohibited, to be acceptable in the case where the operation is not performed for the predetermined period.
(iii) In the case where, after setting the state where the acceptance of the instruction related to the execution of the remote scan job is prohibited, the job, the operation of which is accepted on the operation screen, and which is the type of the job different from the remote scan job, is executed and terminated, the job controller may set the remote scan job, the acceptance of which has been prohibited, to be acceptable.

According to this aspect, in the case where the other job is executed and terminated while the acceptance prohibition state of the remote scan job is set, the remote scan job, the acceptance of which has been prohibited, can be accepted.
(iv) The operation acceptor displays the initial operation screen as the operation screen that is selected by the user in advance with any of the following cases being the trigger, the cases are: the case where the power is on; the case where the image forming apparatus is resumed from the power saving state; and the case of the time-out at which the predetermined period elapses with no operation being performed. When accepting the operation from the user on the initial operation screen, the job controller may determine to accept the operation of the job different from the remote scan job and may set the state where the acceptance of the instruction related to the execution of the remote scan job is prohibited, but may set the state where the remote scan job can be accepted while the operation is not performed on the initial operation screen.

According to this aspect, in the case where the operation is accepted on the initial operation screen, the acceptance prohibition state of the remote scan job is set for the predetermined period. However, in the case where the new operation is not performed for the predetermined period until the operation is accepted or since the operation is accepted, the remote scan job acceptable state can be set.

In the present specification, the power saving state is a state where the power consumption in the standby state for waiting for the instruction related to the job execution is lower than that in the normal standby state. A required period from the acceptance of the instruction related to the job execution to the start of the job is longer than a period in the normal standby state. However, the power consumption in such a state is less than that in the normal standby state. In the power saving state, the image reading apparatus responds to the instruction related to the job execution or to the instruction to resume from the power saving state.
(v) The operation acceptor may display the operation screen to accept, from the user, the operation related to the type of the job different from the remote scan job, and the job controller may determine that switching of the operation screen to the initial operation screen due to the time-out is not caused by the operation by the user, and may not set the instruction related to the execution of the remote scan job as the target of the acceptance prohibition setting.

According to this aspect, when the operation screen is switched to the initial operation screen due to the time-out, it is possible not to set the acceptance prohibition state of the remote scan job in conjunction therewith.
(vi) In the case where the job controller receives the instruction related to the execution of the remote scan job from the external device, and the execution of the remote scan job is in the acceptance prohibition state, the job controller may not accept the instruction. Thereafter, when the condition to cancel the acceptance prohibition state related to the remote scan job is thereafter satisfied, the job controller may cancel the acceptance prohibition state and notify the external device of the state where the instruction related to the execution of the remote scan job can be accepted.

According to this aspect, in the case where the instruction related to the execution of the remote scan job is not accepted in the acceptance prohibition state of the remote scan job, after the other job is executed and terminated, such a fact can be used as the trigger to notify of the state where the instruction related to the execution of the remote scan job can be accepted.
(vii) Another aspect of the present disclosure is the image reading method for causing the controller that controls the image reading apparatus to: receive the instruction related to the execution of the remote scan job from the external device; cause the document reader to read the set document and send the read image to the external device; display the operation screen and accept the operation from the user via the displayed operation screen; and, when accepting the operation via the operation screen, determine that such an operation is the operation related to the job different from the remote scan job, and set the state where the acceptance of the instruction related to the execution of the remote scan job is prohibited onward.

The aspects of the present disclosure include combinations of any of the above-described plural aspects.

Various modifications can be made to the present disclosure in addition to the above-described embodiments. Those modifications should not be construed as falling outside the scope of the present disclosure. The present disclosure is embodied by the claims and their equivalents, and should embrace all modifications within the scope of the claims.

What is claimed is:

1. An image reading apparatus comprising:
a document reader that reads an image of a set document;
a communicator that receives an instruction related to execution of a remote scan job from an external device;
a job controller that controls the document reader to read the document on the basis of the instruction and to send a read image to the external device; and
an operation acceptor that displays an operation screen and accepts an operation from a user via the displayed operation screen, wherein
when accepting the operation via the operation screen, the job controller determines that such an operation is an operation related to a job different from the remote scan job, and sets a state where acceptance of the instruction related to the execution of the remote scan job is prohibited onward.

2. The image reading apparatus according to claim 1, wherein
in the case where a new operation is not performed on the operation screen for a predetermined period since setting of the state where the acceptance of the instruction related to the execution of the remote scan job is prohibited, the job controller sets the remote scan job, the acceptance of which has been prohibited, to be acceptable.

3. The image reading apparatus according to claim 1, wherein
in the case where, after setting the state where the acceptance of the instruction related to the execution of the remote scan job is prohibited, a job, an operation of which is accepted on the operation screen, and which is a job of a type different from the remote scan job, is executed and terminated, the job controller sets the remote scan job, the acceptance of which has been prohibited, to be acceptable.

4. The image reading apparatus according to claim 1, wherein
the operation acceptor displays an initial operation screen as the operation screen that is selected by the user in advance with any of the following cases being a trigger, and the cases are: a case where power is on, a case where the image reading apparatus returns from a power saving state, and a case of time-out at which a predetermined period elapses with no operation being performed, and
when accepting an operation from the user on the initial operation screen, the job controller determines to accept an operation of a job different from the remote scan job and sets the state where the acceptance of the instruction related to the execution of the remote scan job is prohibited, but sets a state where the remote scan job can be accepted while the operation is not performed on the initial operation screen.

5. The image reading apparatus according to claim 4, wherein
the operation acceptor displays the operation screen and accepts, from the user, an operation related to a job of a type different from the remote scan job, and
the job controller determines that switching to the initial operation screen due to the time-out is not caused by the operation by the user, and does not set the instruction related to the execution of the remote scan job as a target of an acceptance prohibition setting.

6. The image reading apparatus according to claim 1, wherein
in the case where the job controller receives the instruction related to the execution of the remote scan job from the external device, and the execution of the remote scan job is in an acceptance prohibition state, the job controller does not accept the instruction, and, when a condition to cancel the acceptance prohibition state related to the remote scan job is thereafter satisfied, the job controller cancels the acceptance prohibition state and notifies the external device of a state where the instruction related to the execution of the remote scan job can be accepted.

7. An image reading method for causing a controller that controls an image reading apparatus to:
receive an instruction related to execution of a remote scan job from an external device;
cause a document set at a document reader to be read and sent to the external device;
display an operation screen and accept an operation from a user via the displayed operation screen; and
when accepting the operation via the operation screen, determine that such an operation is an operation related to a job different from the remote scan job, and set a state where acceptance of the instruction related to the execution of the remote scan job is prohibited onward.
